(19) United States
(12) Patent Application Publication
(10) Pub. No.: US 2026/0085976 A1
(43) Pub. Date: Mar. 26, 2026

(54) OPTICAL MEASUREMENT SYSTEMS WITH MOVING OPTICAL COMPONENTS

(71) Applicant: Apple Inc., Cupertino, CA (US)

(72) Inventors: Alexander Goldis, San Francisco, CA (US); Vijay M. Iyer, Mammoth Lakes, CA (US); Constantin Dory, Saratoga, CA (US); Alexander F. Sugarbaker, Woodside, CA (US)

(21) Appl. No.: 19/331,717

(22) Filed: Sep. 17, 2025

Related U.S. Application Data
(60) Provisional application No. 63/699,684, filed on Sep. 26, 2024.

(51) Int. Cl. G01J 3/02

(52) U.S. Cl. CPC G01J 3/0297; G01J 3/0202; G01J 3/0208

(57) ABSTRACT

Embodiments are directed to optical measurement system, and associated devices, that utilize relative movement between optical components to alter the light that is emitted and collected by the optical measurement system during a measurement. Specifically, the optical measurement system is configured such that vibrations applied to the optical measurement system will generate relative movement between certain optical components of the optical measurement system. Accordingly, the optical measurement system may be vibrated during a measurement to alter one or more properties of light measured by the optical measurement system.

### CROSS-REFERENCE TO RELATED APPLICATIONS

This application claims the benefit under 35 U.S.C. § 119 (e) of U.S. Provisional Patent Application No. 63/699,684, filed Sep. 26, 2024, the disclosure of which is hereby incorporated herein by reference in its entirety.

### FIELD

The described embodiments relate generally to optical measurement systems that include moving optical components. More specifically, the optical measurement systems may utilize compliant mounts to facilitate relative motion between optical components of an optical measurement system.

### BACKGROUND

Optical measurement systems can be used to identify the presence, type, and/or one or more characteristics of objects or substances in the environment surrounding the system. In some instances, an optical measurement system can perform spectroscopic measurements by emitting light at multiple wavelengths and measuring light returned to the system. The relative amounts of light returned at each wavelength may provide information about the nature of the material or materials being measured. Depending on what is being measured by the optical measurement system (e.g., the type or characteristics of a sample that is being measured), the signal-to-noise ratio (“SNR”) for individual measurements can be limited by different noise sources. For example, coherent noise sources, such as speckle noise, may limit the SNR in many instances. Accordingly, it may be desirable to configure an optical measurement system to reduce the amount of noise present in measurements performed by the optical measurement system.

### SUMMARY

Embodiments described herein are directed to optical measurement systems. Some embodiments are directed to an electronic device that includes a haptic actuator, an optical measurement system and a controller. The optical measurement system includes a set of constrained optical components and a set of unconstrained optical components. The controller is configured to operate the optical measurement system to perform a series of measurements during a first period of time and to operate the haptic actuator to vibrate the optical measurement system during the series of measurements. The optical measurement system is configured such that vibration of the optical measurement system during the series of measurements causes the set of unconstrained optical components to vibrate relative to the set of constrained optical components.

In some variations, the controller is configured to operate the haptic actuator to provide haptic feedback to a user during a second period of time. Additionally or alternatively, operation of the haptic actuator may be controlled during the series of measurements such that a first unconstrained optical component of the set of unconstrained optical components vibrates relative to the set of constrained optical components at a corresponding target frequency and with a corresponding target amplitude. In some of these variations, the series of measurements includes a plurality of measurements performed at different sets of wavelengths, where each measurement of the plurality of measurements is performed during a different corresponding vibration period of the first unconstrained optical component. In other variations, the series of measurements includes a plurality of measurements performed at different sets of wavelengths, where the plurality of measurements is performed during a single vibration period of the first unconstrained optical component.

Other embodiments are directed to a method that includes, at an electronic device comprising an optical measurement system and a haptic actuator: performing, during a first period of time, a series of measurements using the optical measurement system. The method further includes vibrating the optical measurement system, using the haptic actuator, during the series of measurements. The optical measurement system includes a set of constrained optical components and a set of unconstrained optical components, such that vibration of the optical measurement system during the series of measurements causes the set of unconstrained optical components to vibrate relative to the set of constrained optical components.

In some variations, the method includes providing haptic feedback to a user of the electronic device during a second period of time. Additionally or alternatively, a first unconstrained optical component of the set of unconstrained optical components may vibrate relative to the set of constrained optical components at a corresponding target frequency and a corresponding target amplitude during the series of measurements. In some of these variations, performing the series of measurements includes performing a plurality of measurements using different sets of wavelengths, where each measurement of the plurality of measurements is performed during a different vibration period of the first unconstrained optical component. In other variations, performing the series of measurements includes performing a plurality of measurements using different sets of wavelengths, where the plurality of measurements is performed during a common vibration period of the first unconstrained optical component.

Still other embodiments are directed to an electronic device that includes an optical measurement system and a controller. The optical measurement system includes a launch assembly configured to generate and emit an input light beam, where the launch assembly includes a set of constrained optical components and a set of unconstrained optical components. The optical measurement system further includes a collection assembly configured to collect one or more return light beams. The controller is configured to operate the optical measurement system to perform a series of measurements while the optical measurement system is vibrated, such that the set of unconstrained optical components vibrates relative to the set of constrained optical components.

In some variations, the electronic device includes a haptic actuator configured to vibrate the optical measurement system during the series of measurements. The optical measurement system may be configured such that vibration of a first unconstrained optical component relative to the set of unconstrained optical components during the series of measurements changes a phase distribution of the input light beam. Additionally or alternatively, the optical measurement system may be configured such that vibration of the first unconstrained optical component relative to the set of unconstrained optical components during the series of measurements changes a trajectory along which the input light beam is emitted from the optical measurement system.

In some variations, the set of unconstrained optical components includes a lens. In some of these variations, the launch assembly comprises a photonic integrated circuit and the lens is mounted to a photonic integrated circuit. Additionally or alternatively, the set of unconstrained optical components may include a diffuser. In some variations, the set of unconstrained optical components includes an integrated optical component formed in a carrier of a compliant mount. In some of these variations, the integrated optical component is a mirror.

In addition to the example aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a block diagram of an electronic device that may incorporate an optical measurement system as described herein. FIG. 1B shows a partial cross-sectional side view of the electronic device of FIG. 1A.

FIG. 2A shows a side view of an example of an optical measurement system, as described herein, that includes a launch assembly and a collection assembly. FIGS. 2B-2F show variations of the launch assembly of the optical measurement system of FIG. 2A.

FIG. 3A shows a perspective view of a portion of a launch assembly of an optical measurement system, as described herein, that includes a fast axis collimating lens that is moveably connected to a photonic integrated circuit via a compliant mount. FIG. 3B shows a magnified view of a region of the launch assembly of FIG. 3A. FIG. 3C shows a side view of a portion of the launch assembly of FIG. 3A.

FIG. 4A shows a top view of a compliant mount as described herein. FIG. 4B shows a top view of a variation of a launch assembly that incorporates a photonic integrated circuit and the compliant mount of FIG. 4A.

FIG. 5 shows a top view of a compliant mount, as described herein, that includes an integrated optical component.

FIGS. 6A and 6B show perspective and side views, respectively, of a variation of a launch assembly, as described herein, that includes a compliant mount that is configured to rotate an optical component of the launch assembly. FIG. 6C shows a side view of a variation of the launch assembly of FIGS. 6A and 6B.

FIGS. 7A and 7B show perspective and side views, respectively, of another variation of a launch assembly, as described herein, that includes a compliant mount that is configured to rotate an optical component of the launch assembly.

FIGS. 8A and 8B show example timing diagrams associated with measurement sessions performed by an optical measurement system, as described herein.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto. It should be also be understood that in figures that show cross-sectional side views, certain components (e.g., windows or the like) may be illustrated without hatching to aid in visualization of the overall devices described herein (e.g., to facilitate viewing the trajectory of light traversing certain components).

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to optical measurement systems that utilize moving optical components to alter light that is emitted and collected during a measurement. Also described herein are electronic devices that incorporate optical measurement systems having moving optical components. The optical measurement system is operable to measure one or more aspects of a sample that is positioned in proximity to the optical measurement system. The optical measurement system is operable to emit a light beam (also referred to herein as an “input light beam”) that is directed into a region of the sample. The optical measurement system is further configured to collect and measure light that has returned to the optical measurement system after interacting with the sample. Certain characteristics of the light collected by optical measurement system may depend on the sample being measured and may thereby provide information about one or more properties of the sample. For example, a portion of the input light beam introduced into a sample may be absorbed as it travels through the sample. The amount of light absorbed may depend, at least in part, on the contents of the sample (e.g., the presence and concentration of different substances within the sample).

In some instances, it may be desirable to alter one or more properties of the light measured by the optical measurement system during a measurement. For example, when coherent light sources, such as lasers, are used to generate the input light beam, measurements performed using coherent illumination may be subject to coherent noise (also referred to herein as “speckle” noise). Specifically, the interference of coherent light as it scatters through a sample may result in a pattern of spatial intensity variations of light that is received and measured by the optical measurement system (also referred to herein as a “coherent noise pattern”). This speckle noise may limit the SNR of a given measurement. Speckle noise may be reduced by changing the coherent noise pattern over the course of a measurement, which may allow for the different coherent noise patterns to be averaged out and thereby increase the SNR of the measurement.

For example, the coherent noise pattern may depend at least in part on the relative phase(s) of light that makes up the input light beam. Specifically, an optical measurement system, such as those described herein, may be configured to generate an input light beam in which different portions of the input light beam have different relative phases. Collectively, these relative phases (also referred to herein as the “phase distribution” of the input light beam) may at least partially determine how light from the input light beam interferes within a sample. Changing the phase distribution of the input light beam, such as within a measurement or between different measurements, change the coherent noise pattern and thereby reduce speckle noise.

In some variations, the optical measurement system may generate a plurality of individual beams of light, where these individual beams of light at least partially overlap to collectively form a larger overall beam. This overall beam may form the input light beam, and may be further modified by other optical components of the optical measurement system before being emitted into a sample. Each of the individual light beams used to generate the input light beam may have a corresponding phase, and the relative phases may at least partially define the phase distribution of the input light beam as it exits the optical measurement system.

Changing the relative phases of the individual beams of light may change the phase distribution of the input light beam, which may reduce speckle noise associated with a measurement. For example, U.S. Patent Publication No. US2024/0102856A1, filed Aug. 16 2023 and titled “Despeckling in Optical Measurement Systems”, which is hereby incorporated by reference in its entirety, discusses examples of photonic integrated circuits that include a phase shifter array, where the phase shifter array is controllable to change the relative phases of light emitted by the photonic integrated circuit as part of a larger overall light beam. Accordingly, some variations of the optical measurement systems described herein may include a phase shifter array, which may controllably change the relative phases of individual light beams that collectively form the input light beam (and thereby change the phase distribution of the input light beam).

Additionally or alternatively, the optical measurement system may be configured such that at least a portion of the input light beam interacts with a diffuser before it exits the optical measurement system, such that the phase distribution of the input light beam is altered by virtue of interacting with the diffuser. For example, a diffuser may be positioned with an optical measurement system such that the input light beam passes through the diffuser before it exits the optical measurement system. The diffuser may act to apply spatially-varying phase changes to light passing through the diffuser. Moving the input light beam relative to the diffuser (or vice versa) may cause the light beam to be incident on a different portion of the diffuser, which may change the distribution of phase changes applied to the input light beam as it passes through the diffuser. In other words, an otherwise identical input light beam entering the diffuser will, upon exiting the diffuser, have a different phase distribution depending on the relative position between the input light beam and the diffuser. Accordingly, an optical measurement system as described herein may be configured to change the relative position between the input light beam and the diffuser to change the coherent noise pattern of light measured by the optical measurement system.

In some instances, such as when a sample being measured by an optical measurement system is heterogeneous in nature, the coherent noise pattern of light measured by the optical measurement system may be changed by interrogating a different sample volume. The sample volume that is measured by an optical measurement system depends at least in part on i) the properties of the input light beam as it enters the sample (the position and angle at which input light beam enters the sample, the size, shape, and divergence of the input light beam as it enters the sample, etc.), ii) the properties of the return light that is collected and measured by the optical measurement system (the position and angle at which a collected light beam exits the sample, the size, shape, and divergence of the collected light beam as it exits the sample, etc.), and iii) the properties of the sample (e.g., a scattering coefficient of the sample, an absorption coefficient of the sample, or the like). By changing the properties of the input light beam and/or the light that is collected and measured by the optical measurement system, the optical measurement system may change the sample volume that is measured.

Accordingly, in some variations of the optical measurement systems described herein, the optical measurement system may be configured to move the input light beam relative to the sample during a measurement. In this way, the input light beam will enter the sample at different positions and/or angles at different times, which may allow the optical measurement system to collect light from different sample volumes. Two different sampling volumes may be associated with different coherent noise patterns, even if there is some overlap between these sampling volumes. Similarly, the optical measurement system may be configured to change how light is collected from the sample, such that the optical measurement system collects light that exits the sample at different positions and/or angles at different times.

In the variations of the optical measurement system described herein, the optical measurement system may utilize relative movement between optical components to alter the light that is emitted and collected by the optical measurement system during a measurement. Specifically, the optical measurement system is configured such that vibrations applied to the optical measurement system will generate the relative movement between certain optical components of the optical measurement system. Accordingly, the optical measurement system may be vibrated during a measurement to alter one or more properties of light measured by the optical measurement system.

For example, the optical measurement systems described herein include a beam generation assembly that is configured to generate the input light beam. The beam generation assembly is configured such that vibration of the beam generation assembly causes relative movement between certain optical components of the beam generation assembly. This, in turn, may cause relative movement between certain components of the beam generation assembly and the input light beam, which may alter the direction of the input light beam and/or one or more properties of the input light beam (e.g., the size, shape, and/or phase distribution of the input light beam). In this way, the optical measurement system (or an electronic device incorporating the optical measurement system) may vibrate the beam generation assembly during measurements performed by the optical measurement system, which may reduce speckle noise associated with these measurements.

It should be appreciated that the optical measurement systems described herein may be configured to simultaneously generate a plurality of different input light beams, each of which may be emitted from a different portion of the optical measurement system. The various concepts are described herein with respect to a single input light beam generated and emitted by an optical measurement system, but it should be appreciated that these concepts may be similarly extended to other input light beams generated by an optical measurement system.

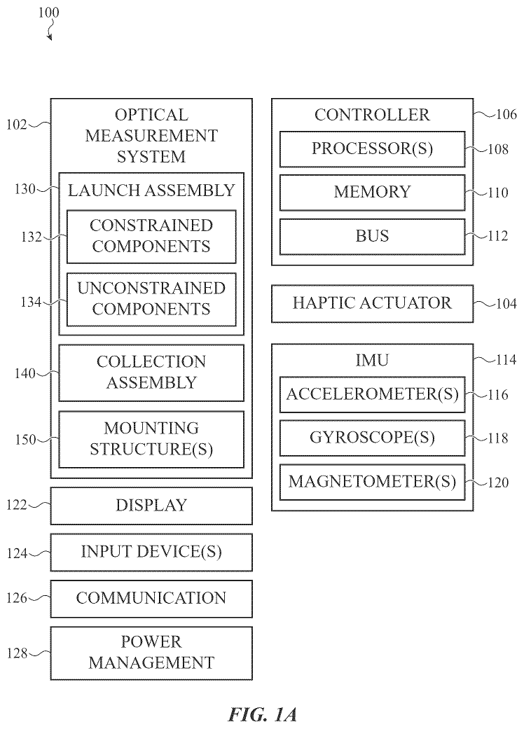

These and other embodiments are discussed below with reference to FIGS. 1A-8B. However, those skilled in the art will readily appreciate that the detailed description given herein with respect to these Figures is for explanatory purposes only and should not be construed as limiting.

FIG. 1A shows a block diagram of an electronic device 100 that may incorporate an optical measurement system 102 as described herein. The electronic device 100, which in some variations is wearable, may operate solely to take measurements using the optical measurement system 102 or may be a multi-functional device capable of performing additional functions, such as will be readily understood by someone of ordinary skill in the art. For example, in some instances the electronic device may be a smart phone, tablet computing device, laptop or desktop computer, a smartwatch, earphone, headset, head-mounted device, or other wearable, or the like.

The electronic device 100 further includes a haptic actuator 104, which may be operated to vibrate the optical measurement system 102 as described herein. Electronic devices often include a haptic actuator that is used to convey information to a user. Specifically, the haptic actuator may be operated to generate controlled vibrations in an electronic device and thereby provide tactile feedback to a user, also referred to herein as “haptic feedback”. A user's sense of touch may be stimulated by imparting relative amounts of force to the user via the vibrations. Different information may be conveyed based on the duration and/or intensity of the vibrations generated by a haptic actuator. For example, different types of haptic feedback may generated by selecting the number, duration, and/or intensity (e.g., constant or varying) of vibrations, and haptic feedback may be tailored to different applications, such as providing notifications or alerts, creating or amplifying a sense of motion (e.g., to give the sense of depressing a button that is immovable or has a relatively short stroke), or the like.

Accordingly, the haptic actuator 104 of the electronic device 100 may be utilized to generate vibrations under a range of different circumstances. For example, the optical measurement system 102 may be configured to perform a measurement session during which the optical measurement system 102 performs a series of individual measurements. During the measurement session, the haptic actuator 104 may be operated to vibrate the optical measurement system 102, which may in turn alter the light that is emitted and measured by the optical measurement system 102 as part of an individual measurement. When the optical measurement system 102 is not actively performing a measurement as part of a measurement session, the haptic actuator 104 may be operated to provide haptic feedback to the user as part of the regular operation of the electronic device. For example, the haptic actuator 104 may provide haptic feedback at the conclusion of a measurement session to notify the user that the measurement sessions has been completed.

The haptic actuator 104 may be configured in any suitable manner. For example, in some variations the haptic actuator 104 includes a mass that is controllably moveable relative to an actuator housing. When an electrical signal is applied to the haptic actuator 104, the mass will move relative actuator housing in a manner that generates vibrations. For example, an eccentric rotating mass (ERM) actuator may utilize an unbalanced mass that is rotated to generate vibrations. In another example, a linear haptic actuator may move a mass, which may be attached to one or more springs, linearly relative to the actuator housing. That said, it should be appreciated than when an electronic device or optical measurement system is described herein as including a haptic actuator, the haptic actuator may be any suitable actuator technology capable of generating vibrations (e.g., an ERM actuator, a linear haptic actuator, a piezoelectric haptic actuator, or the like).

The electronic device 100 may further include a controller 106, which may control operation of the various components of the electronic device 100, including the optical measurement system 102 and the haptic actuator 104. Specifically, the controller 106 may include one or more processors 108, memory 110, and a bus 112 that operatively couples the one or more processors 108 and the memory 110 to other components of the electronic device 100. Additionally, the bus 112 may interconnect different components within the electronic device 100, which may allow for communication between these components.

The one or more processors 108 may include one or more computer processors, each of which can include, for example, a processor, a microprocessor, a programmable logic array (PLA), a generic array logic (GAL), a programmable array logic (PAL), a complex programmable logic device (CPLD), a field-programmable gate array (FPGA), an application-specific integrated circuit (ASIC), or any other programmable logic device (PLD) configurable to execute an operating system and applications of the electronic device 100, as well as to facilitate the various operations described herein.

The memory 110 can include storage, such as a computer-readable storage device. A computer-readable storage device can be any medium that can tangibly contain or store computer-executable instructions for use by the one or more processors 108 to control operation of the electronic device 100. In some examples, the storage device is a transitory computer-readable storage medium. In some examples, the storage device is a non-transitory computer-readable storage medium. The non-transitory computer-readable storage device can include, but is not limited to, magnetic, optical, and/or semiconductor storages, such as magnetic disks, optical discs based on CD, DVD, or Blu-ray technologies, as well as persistent solid-state memory such as flash, solid-state drives, and the like.

The memory 110 may include one or more non-transitory computer-readable storage devices that are used to store computer-executable instructions, which, when executed one or more processors 108, can cause the controller 106 (e.g., via the one or more processors) to control operation of the electronic device 100. For example, a non-transitory computer-readable storage devices may store computer-executable instructions that are run on the one or more processors 108 to perform the various operations that are described herein. Additionally, non-transitory computer-readable storage devices may be used to store information generated or received by the electronic device 100 (e.g., the results of a measurement session performed by the optical measurement system 102).

The electronic device 100 may include a variety of additional components that are used to facilitate operation of the electronic device 100. FIG. 1A shows illustrative set of components that may be included in the electronic device, though is should be appreciated that these components are not intended to be an exhaustive list. Indeed, depending on the configuration of the electronic device 100, the electronic device may include additional components not depicted in FIG. 1A and/or may include a subset of the components depicted in FIG. 1A.

For example, the electronic device 100 may include an inertial measurement unit (“IMU”) 114 that is configured to measure movement of the electronic device 100 and/or determine an orientation of the electronic device 100. The IMU 114 may include one or more sensors, such as one or more accelerometers 116, one or more gyroscopes 118, and/or one or more magnetometers 120, and may utilize signals generated from these sensors to generate motion information and/or orientation information of the electronic device 100.

In some variations, the electronic device may include a display 122. The display 122 may utilize any suitable display technology, and may include a liquid-crystal display (LCD), a light-emitting diode (LED) display, an organic light-emitting diode (OLED) display, an active layer organic light-emitting diode (AMOLED) display, an organic electroluminescent (EL) display, an electrophoretic ink display, or the like. The display 122 may be configured to display graphical outputs, such as graphical user interfaces, that the user may view and interact with. For example, the display 122 may be used to display a graphic output that includes the results of a measurement session performed by the optical measurement system 102.

The display 122 may include or be associated with one or more touch- and/or force-sensing systems. In some cases, components of the touch- and/or force-sensing systems are integrated with a display stack of the display 122. The touch- and/or force-sensing systems may use any suitable type of sensing technology and touch-sensing components, including capacitive sensors, resistive sensors, surface acoustic wave sensors, piezoelectric sensors, strain gauges, or the like. While both touch- and force-sensing systems may be included, in some cases the electronic device 100 includes a touch-sensing system and does not include a force-sensing system. A display that includes touch-sensing functionality may be referred to as a touchscreen or a touchscreen display. A user may, in some instances, interact with the touch- and/or force-sensing systems of the display 122 to initiate a measurement session that will be performed by the optical measurement system 102.

In some variations, the electronic device 100 may include one or more input devices 124, such as buttons, switches, rotatable knob, or the like. A user may apply a force to an input device 124 (e.g., to depressing a button, to rotate a knob) to provide an input to the electronic device 100. For example, a user may apply an input to an input device 124 to initiate a measurement session performed by the optical measurement system 102.

The electronic device 100 may include a communications unit 126 that is configured to allow the electronic device 100 to transmit and/or receive information, such as operating system data and application data, with external equipment (e.g., additional electronic devices, remote servers, or the like). For example, the communications unit 126 may be configured to allow the electronic device 100 to wirelessly communicate with external equipment using cellular, Bluetooth, Wi-Fi, near field communication (NFC), and/or other wireless communications techniques. The communications unit 126 may include any circuitry (e.g., transceiver circuitry) as needed to facilitate communication with external equipment.

The electronic device 100 may include a power management unit 128 that is configured to regulate the distribution of power within the electronic device 100. For example, the power management unit 128 may receive power from an internal power source (e.g., one or more batteries), which in some instances may be rechargeable. Additionally or alternatively, the power management unit 128 may be configured to receive power from an external power source (e.g., using wired or wireless power transmission).

The optical measurement systems described herein are configured to perform, as part of a measurement session, a series of individual measurements on a sample. During an individual measurement, the optical measurement system is configured to emit an input light beam into the sample. While emitting the input light, the optical measurement system measures light that returns from the sample. The relative amount of this light that is returned to the optical measurement system for a given individual measurement may depend on the sample being measured, and may thereby provide information about one or more properties of the sample, such as described in more detail herein.

Accordingly, the optical measurement system 102 of FIG. 1A includes a launch assembly 130 that is configured to generate the input light beam, and a collection assembly 140 that is configured to collect and measure one or more return light beams that enter the optical measurement system 102 while the optical measurement system 102 is emitting the input light beam. The optical measurement system 102 further includes a set of mounting structures 150 to which the launch assembly 130 and the collection assembly 140 are mounted. Specifically, each component of the launch assembly 130 and the collection assembly 140 is connected to set of mounting structures 150, either directly or indirectly (e.g., via one or more intervening components). The set of mounting structures 150 may be a single, monolithic piece of material, or may be a plurality of structural elements that are held in a fixed relationship to each other.

Overall, the set of mounting structures 150 represent a fixed reference point for the optical measurement system 102. Movement of the set of mounting structures 150 represents movement of the entire optical measurement system 102, and vice versa. Accordingly, vibrations generated by the haptic actuator 104 cause the set of mounting structures 150 to vibrate. Accordingly, operation of the haptic actuator 104 to generate vibrations may cause the entire optical measurement system 102 to vibrate.

The launch assembly 130 and the collection assembly 140 each include a correspond set of optical components. As used herein, an “optical component” refers to a component that is capable of generating, measuring, redirecting, or otherwise modifying light within optical measurement system 102. Examples of optical components include, but are not limited to, light sources, photonic integrated circuits, lenses, mirrors, prisms, beamsplitters, diffusers, detector elements, or the like. For example, optical components of the launch assembly 130 may be used to generate and emit the input light beam, whereas optical components of the collection assembly 140 may be used to collect and measure the one or more return light beams. Each optical component of launch assembly 130 and the collection assembly 140 is either connected to the set of mounting structures 150 in a “constrained” manner or an “unconstrained” manner.

Optical components that are constrained relative to the set of mounting structures 150 (also referred to herein as “constrained optical components”) have a predetermined spatial relationship with the set of mounting structure 150, such that vibration of the set of mounting structures 150 does not change the relative position between the optical component and the set of mounting structures 150. The set of mounting structures 150 and the constrained optical components of the optical measurement system 102 are collectively referred to herein as the “fixed portions” or the “constrained portions” of the optical measurement system 102. Conversely, components that are unconstrained relative to the set of mounting structures 150 (also referred to herein as “unconstrained optical components”) are moveably coupled to the set of mounting structures 150 in a manner such that vibration of the set of mounting structures 150 causes the unconstrained optical component to vibrate relative to the set of mounting structures 150.

When vibrations generated by the haptic actuator 104 cause the optical measurement system 102 to vibrate (e.g., by vibrating the set of mounting structures 150), the constrained optical components moved in a fixed relationship with the optical measurement system 102 (e.g., the constrained optical components will maintain there positions relative to each other and relative to the set of mounting structures 150). Conversely, the unconstrained optical components will vibrate within the optical measurement system 102 (e.g., will vibrate relative to the set of mounting structures 150). In this way, vibration of the optical measurement system 102 will cause the unconstrained optical components to vibrate relative to the constrained optical components. This relative movement between optical components may alter one or more properties of the input light beam and/or the return light beam(s).

For example, in the variation of the optical measurement system shown in FIG. 1A, the launch assembly 130 includes a set of constrained optical components 132 and a set of unconstrained optical components 134. Accordingly, vibration of the launch assembly 130 (e.g., via vibration of the optical measurement system 102) will cause set of unconstrainted optical components 134 to vibrate relative to the set of constrained optical components 132. In these variations, the launch assembly 130 is configured such that vibration between the set of constrained optical components 132 and the set of unconstrained optical components 134 changes one or more properties of an input light beam that is generated and emitted by the launch assembly 130. For example, in some variations the launch assembly 130 is configured such that vibration between the set of constrained optical components 132 and the set of unconstrained optical components 134 may change the phase distribution of the input light beam.

Additionally or alternatively, the launch assembly 130 is configured such that vibration between the set of constrained optical components 132 and the set of unconstrained optical components 134 may change the trajectory along which the input light beam is emitted from optical measurement system 102 (and thus the trajectory along which the input light beam is emitted from the electronic device 100 and enters a sample). For example, when the input light beam is emitted from a sampling interface of the electronic device 100 (such as described herein with respect to FIG. 1B), vibration between the set of constrained optical components 132 and the set of unconstrained optical components 134 may change the spatial position at which input light beam exits the sampling interface. In these instances, the input light beam may be moved laterally relative to the sampling interface during vibration of the optical measurement system 102. Additionally or alternatively, vibration between the set of constrained optical components 132 and the set of unconstrained optical components 134 may change the angle at which the input light beam exits the sampling interface. In these instances, the input light beam may be rotated relative to the sampling interface during vibration of the optical measurement system 102.

It should be appreciated that the collection assembly 140 may include only constrained optical components, or may include a combination of constrained and unconstrained optical components (e.g., a corresponding set of unconstrained optical components and a corresponding set of constrained optical components). In variations where the collection assembly 140 includes a corresponding set of unconstrained optical components and a corresponding set of constrained optical components, vibration between the unconstrained optical components and the constrained optical components may cause alter one or more properties of the return light beam(s) collected by the collection assembly 140. For example, vibration of the collection assembly 140 (e.g., via vibration of the optical measurement system 102) may cause changes in the trajectory at which one or more return light beams enter the optical measurement system. For example, when a return light beam is collected through a sampling interface of the electronic device 100, vibration between the unconstrained optical components and the constrained optical components of the collection assembly 140 may change the spatial position at which the return light beam enters the sampling interface and/or may change the angle at which the return light beam enters the sampling interface.

Typically, to generate relative movement between components within an optical measurement system, the optical measurement system may incorporate an actuator (e.g., a voice coil actuator, a piezoelectric actuator, or the like) that is controllable to selectively change the relative position between two components. These actuators may require additional components (e.g., magnets and coils in the example of a voice coil actuator, as well as additional electrical interconnects) that make take up additional space within the optical measurement system and/or may increase the complexity of the design of the optical measurement system. Accordingly, by using the haptic actuator 104 to generate relative movement between unconstrained and constrained optical components within the optical measurement system 102, the optical measurement system 102 may omit one or more actuators and thereby reduce the size and/or complexity of the optical measurement system 102. Additionally, the electronic device 100 may leverage a single haptic actuator 104 for multiple purposes (e.g., to generate relative movement between optical components of the optical measurement system 102 during a measurement, to generate haptic feedback to a user, or the like).

It should be appreciated, however, that the optical measurement system 102 may include an actuator that is configured to selectively move one or more optical components (referred to herein as an “actuated optical component”) within the optical measurement system 102. In these variations, the relative position of the actuated optical component within the optical measurement system 102 may be controlled by the actuator, and thus the actuated optical component may be moved independently of vibrations of the optical measurement system 102. In other words, as the optical measurement system 102 is vibrated, the actuated optical component will be held in a fixed relationship with the other constrained optical components (except to the extent it is controllably moved by a corresponding actuator). Accordingly, for the purpose of this application, an actuated optical component is considered to be a constrained optical component.

Vibrations generated by the haptic actuator 104 may be translated to the optical measurement system 102 in any suitable manner. For example, FIG. 1B shows a cross-section side view of a variation of the electronic device 100 of FIG. 1A. Specifically, the electronic device 100 is shown in FIG. 1B as having a housing 160 that is configured to at least partially enclose the various components of the electronic device 100 and defines a sampling interface 162 of the optical measurement system 102. Specifically, the housing 160 is depicted as a cross-section in FIG. 1B to reveal a side view of certain components of the electronic device 100 that are positioned within the housing 160.

One or more exterior surfaces of the electronic device 100 may define the sampling interface 162 for the optical measurement system 102, through which an input light beam (e.g., generated by the launch assembly 130) can be emitted from the optical measurement system 102 and the electronic device 100. One or more return light beams may also be collected through the sampling interface 162 to re-enter the optical measurement system 102 and the electronic device 100. While the same surface of the electronic device 100 is used as a sampling interface 162 for both emission and collection of light by the optical measurement system 102, it should be appreciated that the sampling interface 162 may span multiple surfaces of the electronic device 100 such that light may be emitted and/or collected from different surfaces of the electronic device 100 (e.g., an input light beam is emitted from the optical measurement system 102 at a portion of the sampling interface 162 on a first surface of the electronic device 100 and one or more return light beams are collected by the optical measurement system 102 at a second portion of the sampling interface 162 on a second surface of the electronic device 100).

The sampling interface 162 may include at least one window. In the variation shown in FIG. 1B, the sampling interface includes a first window (also referred to herein as “launch window 164”) and a second window (also referred to herein as “collection window 166”). The launch assembly 130 may be positioned relative to the sampling interface 162 such that an input light beam 170 generated by the launch assembly 130 exits the sampling interface through the launch window 164. Similarly, the collection assembly 140 may be positioned relative to the sampling interface 162 such that a return light beam 172 collected and measured by the collection assembly 140 enters the optical measurement system through the collection window 166. In other variations, the optical measurement system 102 may be configured to emit the input light beam 170 and collect the return light beam 172 from a common window.

When a sample 180 is placed in contact with the sampling interface, the input light beam 170 may be emitted into the sample 180, and the return light beam 172 may be collected from the sample 180. While individual photons may take different paths through the sample 180, collectively the light measured by the collection assembly 140 via the return light beam 172 will predominantly travel through a particular volume of sample 180. For example, FIG. 1B depicts a sample volume 182 of possible optical paths for light that enters the sample via the input light beam 170 and exits the sample via the return light beam 172.

Specifically, the sample volume 182 represents the possible regions of the sample 180 that may be measured by the collection assembly 140 as part of the return light beam 172 with a minimum threshold probability. In other words, it may be possible for an individual photon to travel outside of the sample volume 182 and still be measured as part of the return light beam 172, but the likelihood of that happening is below the minimum threshold probability. Additionally, to the extent that the collection assembly 140 is capable of collecting and measuring multiple return light beams (e.g., using different detector elements), each return light beam may be associated with a different sample volume of the sample 180. In some of these variations, the collection assembly 140 is configured to collect and measure multiple return light beams that are associated with partially overlapping sample volumes in the sample 180.

The optical measurement system 102 may, as a unit, be held in a fixed position relative to the housing 160. In some variations, such as shown in FIG. 1B, the set of mounting structures 150 may be directly connected to the housing 160. Additionally or alternatively, the set of mounting structures 150 may be configured such that the set of mounting structures 150 form a portion of an exterior surface of the electronic device 100, such as some or all of the sampling interface 162. The haptic actuator 104 is positioned in the housing 160 with a fixed relationship to the optical measurement system 102, such that the optical measurement system 102 will vibrate with the haptic actuator 104.

Specifically, the haptic actuator 104 may be positioned in any suitable manner within the housing 160 that allows for vibrations generated by the haptic actuator 104 to be transmitted to the set of mounting structures 150. Four example and non-exhaustive placement locations (labeled 104a-104d) of the haptic actuator 104 are shown in FIG. 1B. For example, position 104a represents a position in which the haptic actuator 104 is directly connected to the set of mounting structures 150 of the optical measurement system 102. In these instances, vibrations generated by the haptic actuator 104 may be directly transmitted to the set of mounting structures. Position 104b represents a position in which the haptic actuator 104 is directly connected to the housing 160. In these variations, vibrations generated by the haptic actuator 104 may be transmitted to the set of mounting structures 150 via the housing 160. Position 104c represents a position in which the haptic actuator 104 is indirectly connected to the set of mounting structures 150 via one or more intervening structures (represented schematically in FIG. 1B by dashed line 167) such that vibrations generated by the haptic actuator 104 are transmitted to the set of mounting structures 150 through these intervening structures. Similarly, position 104d represents a position in which the haptic actuator 104 is indirectly connected to the housing 160 via one or more intervening structures (represented schematically in FIG. 1B by dashed line 168) such that vibrations generated by the haptic actuator 104 are transmitted to the set of mounting structures 150 through the housing 160 and these intervening structures. It should be appreciated that there may be multiple structural connections between the haptic actuator 104 and the set of mounting structures 150, which provide multiple pathways along which vibrations may be conveyed from the haptic actuator 104 to the set of mounting structures 150.

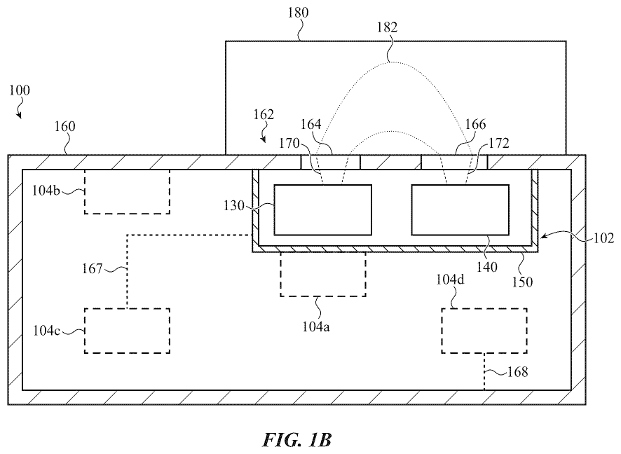

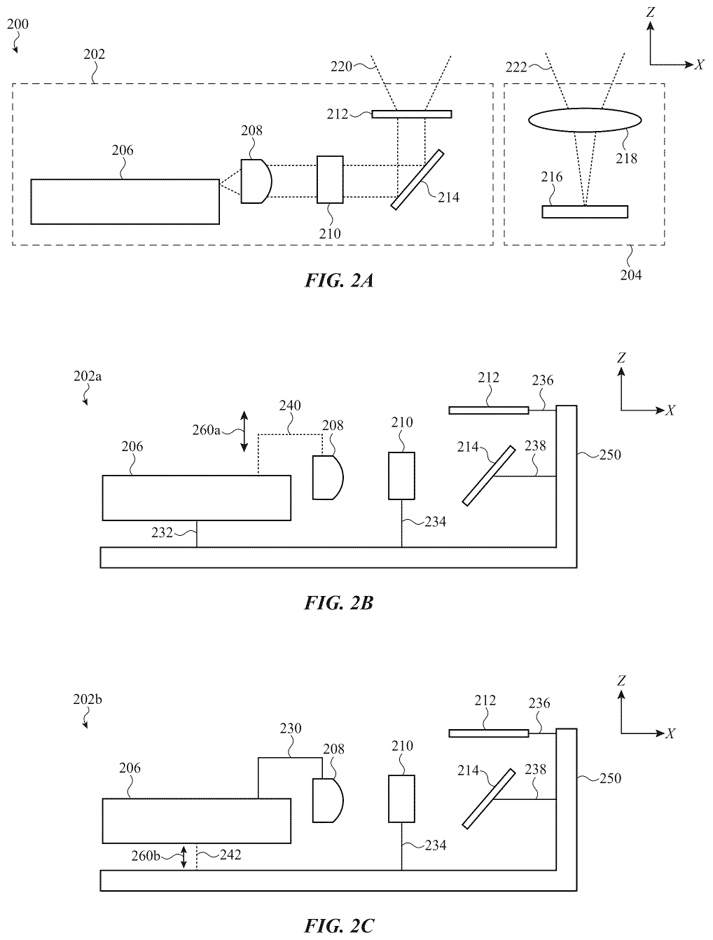

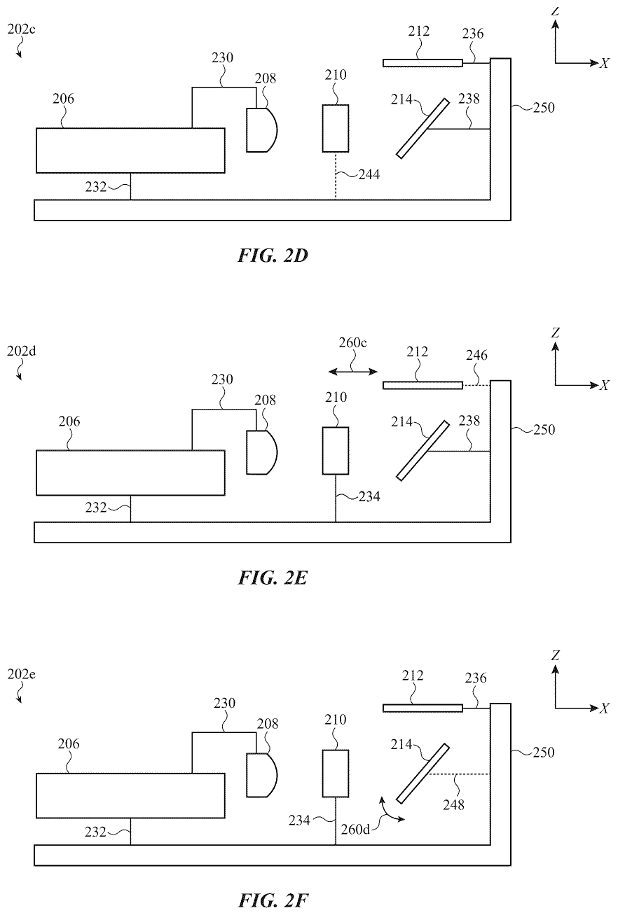

The launch and collection assemblies of the optical measurement systems described herein may include any suitable combination of optical components as may be desired to generate an input light beam and collect one or more return light beams. FIG. 2A shows a side view of an example of an optical measurement system 200 that includes a launch assembly 202 and a collection assembly 204. The launch assembly 202 is configured to generate and emit an input light beam 220, whereas the collection assembly 204 is configured to collect one or more return light beams (represented by a single return light beam 222) when the launch assembly 202 is emitting the input light beam 220.

As shown in FIG. 2A, the launch assembly 202 includes a photonic integrated circuit 206, a set of lenses (e.g., including a fast axis collimating lens 208 and a slow axis collimating lens 210), a diffuser 212, and a beam-redirecting optical component 214. It should be appreciated that, depending on the design of the optical measurement system 200, the launch assembly 202 may include only a subset of these optical components and/or may include additional optical components. The photonic integrated circuit 206 includes a set of outcouplers (not shown), each of which is configured to emit a corresponding individual light beam from the photonic integrated circuit 206. Specifically, the photonic integrated circuit 206 includes one or more light sources (not shown) configured to generate light that is emitted via the set of outcouplers. In some variations, an individual light beam from a single outcoupler forms the input light beam 220. In other variations, the photonic integrated circuit 206 includes a plurality of output couplers that is configured to emit a corresponding plurality of individual light beams. The plurality of individual light beams at least partially overlap and collectively form the input light beam 220. In variations where the input light beam 220 is formed from a plurality of individual beams, the relative phases of these individual beams may be changed (e.g., using an array of phase shifters incorporated into the photonic integrated circuit 206) to change the phase distribution of the input light beam 220.

The set of outcouplers of the photonic integrated circuit may be configured in any suitable manner, and may include edge couplers, vertical output couplers, or the like. For example, in some variations each outcoupler of the set of outcouplers is configured as an edge coupler, such that a corresponding portion of a side surface of the photonic integrated circuit 206 acts as an output facet from which a corresponding individual light beam may be emitted. For example, each outcoupler of the set of outcouplers may include a portion of a side of the photonic integrated circuit 206 that is shaped to form an on-chip lens, such as described in U.S. Patent Publication No. US2023/0089758A1, titled “Light Output Devices and Light Outputting Methods for Optical Systems”, the contents of which are hereby incorporated by reference in their entirety.

When the photonic integrated circuit 206 emits the input light beam 220 (e.g., as a single light beam or multiple overlapping individual light beams), the input light beam 220 may diverge differently in different directions. For example, the input light beam 220 may, upon exiting the photonic integrated circuit 206, have a higher divergence in a first dimension (hereinafter referred to as the “fast axis) than its divergence in a second dimension perpendicular to the first dimension (hereinafter referred to as the “slow axis”). For example, the fast axis and the slow axis may be oriented along a Z-axis and a Y-axis (e.g., into the page), respectively, of the cartesian coordinate system shown in FIG. 2A. In some variations, the input light beam 220 may be wider along the slow axis than it is along the fast axis.

In some variations, the launch assembly 202 may be configured to at least partially collimate the input light beam 220 along the fast and slow axes. For example, in the variation shown in FIG. 2A, the fast axis collimating lens 208 is configured to at least partially collimate the input light beam 220 along its fast axis and the slow axis collimating lens 210 is configured to at least partially collimate the input light beam 220 along its slow axis. The fast axis collimating lens 208 and the slow axis collimating lens 210 may at least partially define the size and shape of the input light beam 220 as it exits the optical measurement system 200.

In variations in which the launch assembly 202 includes a diffuser 212, the input light beam 220 may be directed to pass through the diffuser 212. The diffuser 212 may alter the phase distribution of the input light beam 220 and increase the divergence of the input light beam 220 (e.g., along both the fast axis and the slow axis) as the input light beam 220 travels through the diffuser 212.

In some variations, the launch assembly 202 also includes a set of beam-directing components, such as beam-redirecting optical component 214, that is configured to redirect at least a portion of the input light beam 220. In some of these variations, the set of beam-redirecting optical components may include a mirror, prism, or the like that is configured to redirect the entire input light beam 220. Additionally or alternatively, the set of beam-redirecting optical components includes a beamsplitter. The beamsplitter is configured to split off a portion of the input light beam 220 as a reference light beam (not shown). At least a portion of the reference light beam may be directed to a reference detector (not shown), which may measure an intensity of the reference light beam. Measurements from the reference detector may be used by the optical measurement system 200 (e.g., using a controller such as controller 106) to account for fluctuations in the intensity of the reference light beam (which may represent fluctuations in the intensity of the input light beam 220 that is emitted from the optical measurement system 200).

In the variation of the collection assembly 204 shown in FIG. 2A, the collection assembly 204 includes a set of detector elements 216 and a set of lenses (represented by a single lens 218). The set of lenses is configured to collect, for each detector element of the set of detector elements, a corresponding return light beam (e.g., return light beam 222). In some instances, the collection assembly 204 may include additional optical components, such as aperture layers, polarizers, filters, beam-redirecting optical components, or the like, that may at least partially control the light that is received by the set of detector elements. Each detector element of the set of detector elements 216 may output a corresponding measurement signal during an individual measurement (e.g. corresponding to the return light beam measured by that detector element) that represents the amount of light that is measured by the detector element during that individual measurement. The measurement signal generated during an individual measurement may provide an indication of the relative amount of the input light beam 220 that is returned to the optical measurement system from a given exit location of a sample.

The optical measurement system 200 of FIG. 2A may include a combination of constrained and unconstrained optical components. For example, FIGS. 2B-2E show side views of different variations of the launch assembly 202 of FIG. 2A (labeled 202a-202e, respectively), which illustrate the different arrangements of constrained and unconstrained optical components (e.g., as indicated relative to a mounting structure 250 that represents a fixed portion of the optical measurement system 200 of FIG. 2A). In these figures, solid lines are used to illustrate fixed spatial relationships between components and dashed lines are used to illustrate moveable spatial relationships between components (which may facilitate movement of an unconstrained optical component).

For example, FIG. 2B shows a first variation of the launch assembly 202a, in which the fast axis collimating lens 208 is configured as an unconstrained optical component. In the variation shown in FIG. 2B, the fast axis collimating lens 208 is moveably connected to the photonic integrated circuit 206 (as indicated by dashed line 240), and the photonic integrated circuit 206 is held in a fixed relationship with the mounting structure 250 (as indicated by solid line 232). Accordingly, the photonic integrated circuit 206 is configured as a constrained optical component. In other variations, the fast axis collimating lens 208 may be moveably connected to the mounting structure 250, or may be moveably connected to another constrained optical component of the optical measurement system 200.

In variations in which the fast axis collimating lens 208 is an unconstrained optical component and the photonic integrated circuit 206 is a constrained optical component, vibration of the mounting structure 250 will cause the fast axis collimating lens 208 to vibrate relative to the photonic integrated circuit 206 as well as the other fixed portions of the optical measurement system 200 (e.g., the mounting structure 250 and the constrained optical components of the optical measurement system 200). When the photonic integrated circuit 206 is operated to emit the input light beam 220, the fast axis collimating lens 208 may move relative to the input light beam 220. In some of these variations, the fast axis collimating lens 208 may be configured to vibrate along the fast axis of the input light beam 220 (e.g., along the Z-axis of FIG. 2B as indicated by arrow 260a). In these variations, movement of the fast axis collimating lens 208 relative to the photonic integrated circuit 206 (and thereby relative to the input light beam 220) along the fast axis may rotate the input light beam 220 around its slow axis as it exits the fast axis collimating lens 208. This rotation may change the angle at which the input light beam 220 exits the optical measurement system 200, which may change the sample volume(s) measured by the set of detector elements 216 of the collection assembly 204. In these variations, the input light beam 220 may, during vibration of the optical measurement system 200, rotate around its slow axis as it exits the optical measurement system.

Additionally, depending on the configuration of the launch assembly 202a, rotation of the input light beam 220 may cause the input light beam 220 to be incident on and interact with (e.g., pass through) different portions of the diffuser 212. This may change the distribution of phase changes applied to the input light beam 220 as it passes through the diffuser. In the variation of the launch assembly 202a shown in FIG. 2A, the slow axis collimating lens 210, the diffuser 212, and the beam-redirecting optical component 214 are configured as constrained optical components that are fixed relative to the mounting structure 250 (as indicated by respective solid lines 234, 236, and 238). It should be appreciated, however, that one or more of these components may instead be configured as an unconstrained optical component depending on the design of the optical measurement system 200.

FIG. 2C shows another variation of the launch assembly 202b, in which both the photonic integrated circuit 206 and the fast axis collimating lens 208 are configured as unconstrained optical components. In these variations, vibration of the mounting structure 250 will cause both the photonic integrated circuit 206 and the fast axis collimating lens 208 to vibrate relative to the mounting structure 250. In the variation shown in FIG. 2C, the photonic integrated circuit 206 and the fast axis collimating lens 208 may be held in a fixed relationship to each other (as indicated by solid line 230), such that the photonic integrated circuit 206 and the fast axis collimating lens 208 move together as they vibrate relative to the mounting structures. The photonic integrated circuit 206 may be moveably connected to the mounting structure 250 (as indicated by dashed line 242).

In some of these variations, the photonic integrated circuit 206 and the fast axis collimating lens 208 may be configured to vibrate together along the fast axis of the input light beam 220 (e.g., along the Z-axis as indicated by arrow 260b). When the photonic integrated circuit 206 is generating and emitting the input light beam 220, this may cause the input light beam to laterally translate along the fast axis of the input light beam 220 (e.g., along the Z-axis of FIG. 2C). This translation may change the location (e.g., the spatial location along a sampling interface) at which the input light beam 220 exits the optical measurement system 200. In this way, the exit location of the input light beam 220 may be scanned along a direction corresponding to the fast axis. Additionally, depending on the configuration of the launch assembly 202b, translation of the input light beam 220 may cause the input light beam 220 to be incident on (and pass through) different portions of the diffuser 212, which may change the phase distribution of input light beam 220.

Additionally or alternatively, the photonic integrated circuit 206 and the fast axis collimating lens 208 may be configured to vibrate together along the slow axis of the input light beam 220 (e.g., along the Y-axis). When the photonic integrated circuit 206 is generating and emitting the input light beam 220, this may cause the input light beam 220 to laterally translate along the slow axis of the input light beam 220. Accordingly, this translation may cause the exit location of the input light beam 220 to be scanned along a direction corresponding to the slow axis of the input light beam 220. In variations in which the slow axis collimating lens 210 is configured as a constrained optical component, the input light beam 220 may also be rotated around is fast axis as the input light beam 220 is moved relative to the slow axis collimating lens 210 along the slow axis.

In the variation of the launch assembly 202b shown in FIG. 2C, the slow axis collimating lens 210, the diffuser 212, and the beam-redirecting optical component 214 are configured as constrained optical components that are fixed relative to the mounting structure 250 (as indicated by respective solid lines 234, 236, and 238). It should be appreciated, however, that one or more of these components may instead be configured as an unconstrained optical component depending on the configuration of the optical measurement system 200.

FIG. 2D shows a variation of the launch assembly 202c in which the slow axis collimating lens 210 is configured as an unconstrained optical component. Specifically, the slow axis collimating lens 210 may be moveably connected to the mounting structure 250 (as indicated by dashed line 244), such that vibration of the mounting structure 250 causes the slow axis collimating lens 210 to vibrate relative to the mounting structure 250 and may thereby vibrate relative to the constrained optical components of the optical measurement system 200.

In some variations, the launch assembly 202c is configured such that vibration of the mounting structure 250 causes the slow axis collimating lens 210 to vibrate along the slow axis of the input light beam 220 (e.g., along the Y axis, into and out of the page of FIG. 2D). In some of these variations, the photonic integrated circuit 206 is a constrained optical component and is held in a fixed relationship with the mounting structure 250 (as indicated by solid line 232). Accordingly, vibration of the mounting structure 250 may cause the slow axis collimating lens 210 to vibrate relative to the photonic integrated circuit 206 (and thereby relative to the input light beam 220) along the slow axis of the input light beam 220. This may rotate the input light beam 220 around its fast axis as it exits the slow axis collimating lens 210, which may change the angle at which the input light beam 220 exits the optical measurement system 200. For example, this relative movement between the slow axis collimating lens 210 and the input light beam 220 may, during vibration of the optical measurement system 200, rotate the input light beam 220 around its fast axis as it exits the optical measurement system 200.

In other variations, the photonic integrated circuit 206 may be configured as an unconstrained optical component, and may be configured to vibrate in a fixed relationship with the slow axis collimating lens 210. For example, the photonic integrated circuit 206 and the slow axis collimating lens 210 may vibrate together along the slow axis of the input light beam 220. When the photonic integrated circuit 206 is generating and emitting the input light beam 220, this may cause the input light beam to laterally translate along the slow axis of the input light beam 220. This may cause the exit location of the input light beam 220 may be scanned along a direction corresponding to its slow axis.

FIG. 2E shows still another variation of the launch assembly 202d, in which the diffuser 212 is configured as an unconstrained optical component. Specifically, the diffuser 212 may be moveably connected to the mounting structure 250 (as indicated by dashed line 246), such that vibration of the mounting structure 250 causes the diffuser 212 to vibrate relative to the mounting structure 250 and other fixed portions of the optical measurement system 200. In some variations, the launch assembly 202d may be configured such that the diffuser 212 may vibrate laterally relative to the input light beam 220 (e.g., along the slow axis and/or fast axis of the input light beam 220, such as indicated by arrow 260c). In these instances, lateral relative movement between the diffuser 212 and the input light beam 220 may change the phase distribution of the input light beam 220 as it exits the diffuser 212. Accordingly, in variations in which the other optical components of the launch assembly 202d (e.g., the photonic integrated circuit 206, the fast axis collimating lens 208, the slow axis collimating lens 210, and the beam-redirecting optical component 214) are configured as constrained optical components, the input light beam 220 may exit the optical measurement system 200 along a fixed trajectory (e.g., may exit the optical measurement system 200 at a fixed location and angle relative to a sampling interface), but with a varying phase distribution during vibration of the optical measurement system 200.

FIG. 2F shows a variation of the launch assembly 202e in which the beam-redirecting optical component 214 is configured as an unconstrained optical component. The beam-redirecting optical component 214 may be moveably connected to the mounting structure 250 (as indicated by dashed line 248), such that vibration of the mounting structure 250 causes the beam-redirecting optical component 214 to vibrate relative to the mounting structure 250 and other fixed portions of the optical measurement system 200. For example, the beam-redirecting optical component 214 may be configured to rotate (e.g., as indicated by line 260d) and/or translate relative to the constrained optical components of the launch assembly 202e (which, in the variation shown in FIG. 2F includes the photonic integrated circuit 206, the fast axis collimating lens 208, the slow axis collimating lens 210, and the diffuser 212). This relative motion may cause the beam-redirecting optical component 214 to rotate and/or translate relative to the input light beam 220, which may change how the beam-redirecting optical component 214 directs the input light beam 220. For example, movement of the beam-redirecting optical component 214 may be configured to rotate the input light beam 220 and/or translate the input light beam 220 as it exits the optical measurement system 200.

It should be appreciated that the variations of the launch assemblies 202a-202e of FIGS. 2B-2F are just a few examples of possible arrangements of constrained and unconstrained optical components within the launch assembly of an optical measurement system. In some variations, for example, a launch assembly may include multiple unconstrained optical components that are configured to vibrate in different directions and/or at different frequencies when the optical measurement system is vibrated. For example, in one variation of the optical measurement system 200 of FIG. 2A, the photonic integrated circuit 206 may be a constrained optical component, and the fast axis collimating lens 208 and the slow axis collimating lens 210 may each be unconstrained optical components. The fast axis collimating lens 208 may be configured to vibrate in a first direction and frequency relative to the input light beam 220 (e.g., along the fast axis of the input light beam 220), and the slow axis collimating lens 210 may be configured to vibrate in a second direction and frequency relative to the input light beam 220 (e.g., along the slow axis of the input light beam 220). Accordingly the fast axis collimating lens 208 and the slow axis collimating lens 210 may rotate the input light beam 220 in different directions, which may provide two-dimensional scanning of the input light beam 220 as it exits the optical measurement system 200.

In another example of the optical measurement system 200 of FIG. 2A, the photonic integrated circuit 206 may be movably connected to the mounting structure 250, and the fast axis collimating lens 208 may be moveably connected to the photonic integrated circuit 206, such that the photonic integrated circuit 206 and the fast axis collimating lens 208 are both configured as unconstrained optical components. In some of these variations, the optical measurement system 200 may be configured such that, when the optical measurement system 200 is vibrated, the photonic integrated circuit 206 and the fast axis collimating lens 208 will vibrate together in a first direction relative to the fixed portions of the optical measurement system 200 (e.g., along the slow axis of the input light beam 220), and the fast axis collimating lens 208 will vibrate relative to the photonic integrated circuit 206 in a different section direction (e.g., along the fast axis of the input light beam 220). This may similarly provide two-dimensional scanning of the input light beam 220 as it exits the optical measurement system 200.

To facilitate the relative vibration of unconstrained optical components within an optical measurement system, an unconstrained optical component may be moveably connected to a set of mounting structures (either directly or indirectly via one or more intermediate components) using a compliant mount. For example, any of the unconstrained optical components of the launch assemblies 206a-206e described herein with respect to FIGS. 2B-2F may be moveably connected to a fixed portion of the optical measurement system 200 using a compliant mount. A compliant mount as described herein may include a base, a carrier, and a set of flexible connectors that moveably connect the carrier to the base. The set of flexible connectors may be able to elastically deform to allow for relative movement between the base and the carrier. Accordingly, the base of the compliant mount may be connected to the set of mounting structures (either directly or indirectly via one or more intermediate components, such as a constrained optical component or an unconstrained optical component as described herein), such that vibration of the set of mounting structures causes the base to vibrate. The compliant mount is configured such that vibration of the base will cause the carrier to vibrate relative to the base via elastic deformation of the set of flexible connectors.

The carrier may house or otherwise incorporate an unconstrained optical component of the optical measurement system, such that the carrier and the unconstrained optical component move together in a fixed relationship. Accordingly, vibrating the base of the compliant mount may vibrate the unconstrained optical component relative to the fixed portions of an optical measurement system. The frequency and amplitude at which the carrier vibrates relative to base depends at least in part on the resonant frequency of the compliant mount and the frequency and direction of the vibrations of the base. Accordingly, the optical measurement system may be configured to tune the relationship between vibrations generated by a haptic actuator and the relative vibration of unconstrained optical components within the optical measurement system.

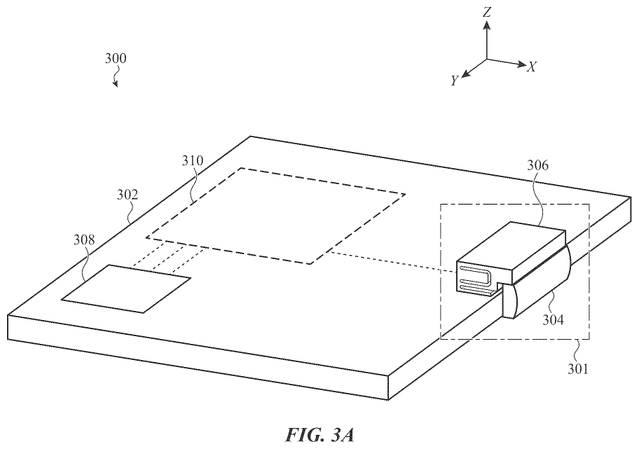

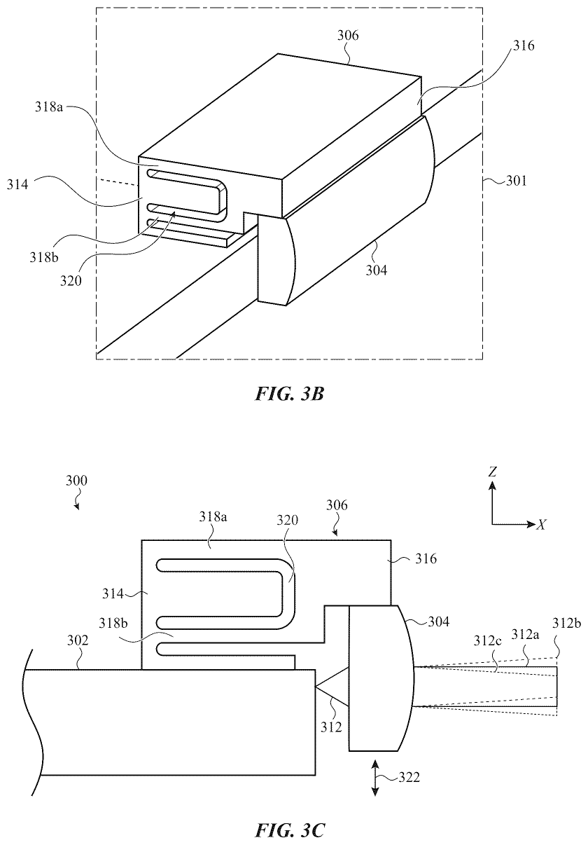

FIGS. 3A-7B depict variations of unconstrained optical components of optical measurement systems, such as those described herein, in which a compliant mount is used to moveably connect the unconstrained optical component to a set of mounting structures. For example, FIG. 3A shows a perspective view of a portion of a launch assembly 300 of an optical measurement system that includes a photonic integrated circuit 302 and a lens 304, where the lens 304 is moveably connected to the photonic integrated circuit 302 via a compliant mount 306. FIG. 3B shows a magnified view of the region 301 of the launch assembly 300 depicted in FIG. 3A, and FIG. 3C shows a side view of a portion of the launch assembly 300. In these variations, the lens 304 is configured as an unconstrained optical component. In the example shown in FIGS. 3A-3C, the lens 304 is configured as a fast axis collimating lens and referred to herein as “fast axis collimating lens 304”, though it should be appreciated that these principles may be extended to any type of lens as may be desired.

The photonic integrated circuit 302 may include a light source unit 308 that is configured to generate the light used to emit an input light beam 312 (such as shown in FIG. 3C) from the photonic integrated circuit 302. The light source unit 308 includes a set of light sources (not shown), each of which is selectively operable to emit light at a corresponding set of wavelengths. Each light source may be any component capable of generating light at one or more particular wavelengths, such as a light-emitting diode or a laser. A laser may include a semiconductor laser, such as a laser diode (e.g., a distributed Bragg reflector laser, a distributed feedback laser, an external cavity laser), a quantum cascade laser, or the like. A given light source may be single-frequency (fixed wavelength) or may be tunable to selectively generate one of multiple wavelengths (e.g., the light source may be controlled to output different wavelengths at different times). The set of light sources may include any suitable combination of light sources, and collectively may be operated to generate light at any of a plurality of different wavelengths. Accordingly, the input light beam 312 generated and emitted by the photonic integrated circuit 302 may include light of a corresponding set of one or more wavelengths at any given time. The wavelength or wavelengths used to form the input light beam 312 may be changed over time (e.g., between different individual measurements of a measurement session, such as described in more detail herein). The photonic integrated circuit 302 may include a set of photonic components 310 that is configured to route light generated by the light source unit 308 to a set of outcouplers (not shown) that is used to emit the input light beam 312 from the photonic integrated circuit 302. The set of photonic components 310 may include any combination of photonic components as may be needed to generate and emit the input light beam from the photonic integrated circuit 302.

The compliant mount 306 includes a base 314, a carrier 316, and a set of flexible connectors 318a-318b moveably connecting the carrier 316 to the base 314. In the variation of the compliant mount 306 shown in FIGS. 3A-3B, the set of flexible connectors 318a-318b is configured as a set of flexures (e.g., a first flexure 318a and a second flexure 318b) that suspend the carrier 316 relative to the base 314. The compliant mount 306 is formed from as a monolithic structure, in which the base 314, the carrier 316, and the set of flexible connectors 318a-318b are formed from a single piece of material. In these variations, the piece of material may define one or more openings 320 that extend through the piece of material to define the base 314, the carrier 316, and the set of flexible connectors 318a-318b. In other variations, the compliant mount 306 may be formed from multiple separate pieces of materials that are connected to each other.

When the launch assembly 300 is vibrated, the photonic integrated circuit 302 may also vibrate. For example, in variations where the photonic integrated circuit 302 is configured as a constrained optical component of the launch assembly 300, the photonic integrated circuit 302 may vibrate with the launch assembly 300 (and the other fixed portions of an optical measurement system that incorporates the launch assembly 300). Alternatively, in variations where the photonic integrated circuit 302 is configured as an unconstrained optical component of the launch assembly 300, the photonic integrated circuit 302 may vibrate within the launch assembly 300 (e.g., vibrate relative to the fixed portions of the launch assembly 300). In both instances, the vibration of the photonic integrated circuit 302 may cause the fast axis collimating lens 304 to vibrate relative to the photonic integrated circuit 302, as well as relative to the fixed portions of the launch assembly 300.

Specifically, the base 314 may be attached to the photonic integrated circuit 302 (e.g., mounted to a top surface of the photonic integrated circuit 302 as shown in FIGS. 3A-3C, mounted to a bottom surface of the photonic integrated circuit 302, or mounted to a side surface of the photonic integrated circuit 302), such that the base 314 is fixed relative to the photonic integrated circuit 302. Similarly, the fast axis collimating lens 304 may be attached to the carrier 316 such that the fast axis collimating lens 304 is fixed relative to the carrier 316. Because the base 314 is held in a fixed relationship with the photonic integrated circuit 302, vibrations of the photonic integrated circuit 302 will also cause the base 314 to vibrate. As the base 314 vibrates, the set of flexible connectors 318a-318b may elastically deform and facilitate vibration of the carrier 316 relative to the base 314. Accordingly, vibration between the base 314 and the carrier 316 of the compliant mount 306 will vibrate the fast axis collimating lens 304 relative to the photonic integrated circuit 302.

The launch assembly 300 is configured such that, when the photonic integrated circuit 302 generates and emits the input light beam 312, the fast axis collimating lens 304 is positioned in the path of the input light beam 312. Accordingly, the input light beam 312 will pass through the fast axis collimating lens 304 and may be at least partially collimated along its fast axis. In the variation shown in FIGS. 3A-3C, the compliant mount 306 may be configured to vibrate the fast axis collimating lens 304 relative to the photonic integrated circuit 302 along the fast axis of the input light beam 312 (as indicated by arrow 322 in FIG. 3C). In these variations, the fast axis collimating lens 304 may vibrate relative to the input light beam 312 along its fast axis, which may change an angle at which the input light beam 312 exits the fast axis collimating lens 304. For example, FIG. 3C shows a first exit trajectory 312a of the input light beam 312 that may occur when the fast axis collimating lens 304 is positioned as shown in FIG. 3C. FIG. 3C also shows a second exit trajectory 312b and a third exit trajectory 312c of the input light beam as the fast axis collimating lens 304 is moved downward and upward, respectively, relative to the position shown in FIG. 3C.

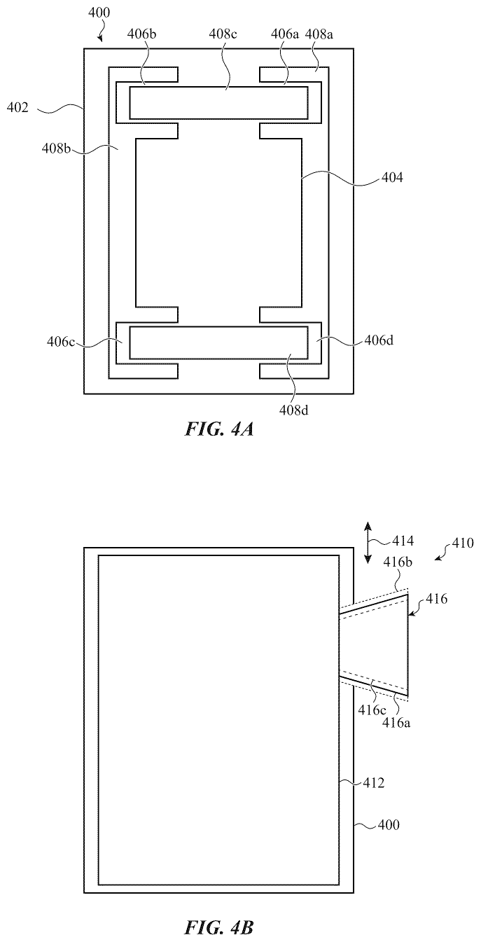

In variations in which a photonic integrated circuit of a launch assembly is configured as an unconstrained optical component, a compliant mount may moveably connect the photonic integrated circuit within an optical measurement system. For example, FIGS. 4A and 4B depict an instance of a launch assembly 410 in which a compliant mount 400 may moveably connect a photonic integrated circuit 412 to a fixed portion of the launch assembly 410. Specifically, FIG. 4A shows a top view of the compliant mount 400. The compliant mount 400 includes a base 402, a carrier 404, and a set of flexible connectors 406a-406d moveably connecting the carrier 404 to the base 402. The set of flexible connectors 406a-406d may be configured as a set of flexures (e.g., including a first flexure 406a, a second flexure 406b, a third flexure 406c, and a fourth flexure 406d) that suspend the carrier 404 relative to the base 402.

In the variation shown in FIG. 4A, the compliant mount 400 may have a planar shape, such that the base 402, the carrier 404, and the set of flexible connectors 406a-406d are positioned in a common plane. In these variations, the carrier 404 may be moveable relative to the base 402 within this common plane. In some of these variations, the compliant mount 400 may be formed from a single sheet of material, in which some of the material is removed to define the base 402, the carrier 404, and the set of flexible connectors 406a-406d. For example, the compliant mount 400 may be processed to define a set of openings 408a-408d that extend through the compliant mount 400, and thereby at least partially define the base 402, the carrier 404, and the set of flexible connectors 406a-406d. While the base 402 is shown in FIG. 4A as at least partially surrounding the carrier 404, it should be appreciated that in other variations the carrier 404 may at least partially surround the base 402.

FIG. 4B shows a top view of the launch assembly 410, in which the photonic integrated circuit 412 is mounted to the compliant mount 400. Specifically, the photonic integrated circuit 412 may be attached to the carrier 404, such that the photonic integrated circuit 412 is held in a fixed relationship with the carrier 404. Conversely, the base 402 may be connected to a fixed portion of the launch assembly 410. Accordingly, the set of flexible connectors 406a-406d may suspend the photonic integrated circuit 412 relative to the base 402.

When the launch assembly 410 is vibrated, the base 402 of the compliant mount 400 will also vibrate. As the base 402 vibrates, the set of flexible connectors 406a-406d may elastically deform and facilitate vibration of the carrier 404 relative to the base 402. Accordingly, vibration between the base 402 and the carrier 404 of the compliant mount 400 will vibrate the photonic integrated circuit 412 relative to the fixed portions of the launch assembly 410.

For example, the launch assembly 410 may be configured such that vibration of the base 402 causes the carrier 404 and the photonic integrated circuit 412 to vibrate relative to the base 402 in a direction (as indicated by arrow 414) along the slow axis of an input light beam 416 emitted by the photonic integrated circuit 412. In these instances, vibration of the photonic integrated circuit 412 relative to the base 402 along direction 414 will laterally shift the input light beam 416, relative to constrained optical components of the launch assembly 410, along its slow axis. This may result in scanning of the input light beam 416 as it exits the optical measurement system that incorporates the launch assembly 410, such as described in more detail herein. FIG. 4B shows a trajectory 416a of the input light beam 417 that may occur when the photonic integrated circuit 412 is positioned as shown in FIG. 4B. FIG. 4B also shows a second trajectory 416b and a third trajectory 416c of the input light beam 416 as the photonic integrated circuit 412 is moved in either direction relative to the base 402.

It should be appreciated that the compliant mount 400 shown in FIG. 4A may be configured to moveably connect other unconstrained optical components to the fixed portion of an optical measurement system as described herein. For example, in some variations, an optical component such as a diffuser (e.g., the diffuser 212 of FIG. 2A), a lens (e.g., the fast axis collimating lens 208 or the slow axis collimating lens 210 of FIG. 2A), or a beam-redirecting optical component (e.g., the beam-redirecting optical component 214 of FIG. 2A) may be attached with a fixed relationship to the carrier 404, such that the optical component moves with the carrier 404. In some variations where light (e.g., an input light beam) is configured to pass through the optical component, such as a diffuser or a lens, the carrier 404 may define an aperture that extends through the carrier 404. In these variations, the optical component may be positioned at least partially over and/or within the aperture, such that the optical component modifies light that passes through the aperture. In other variations, the carrier 404 may be formed from a material that is transparent to the wavelength(s) of that light, such that light passing through the optical component also passes through the carrier 404.

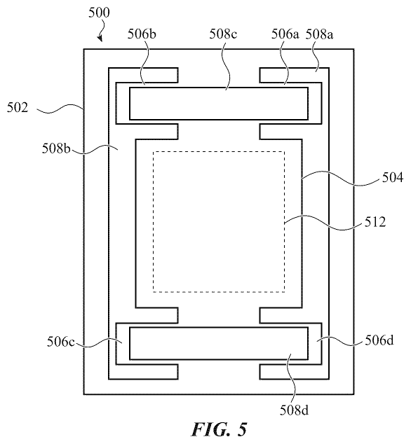

Additionally or alternatively, an optical measurement system as described herein may include an unconstrained optical component that is formed from a portion of the carrier of a compliant mount. For example, FIG. 5 shows a top view of a compliant mount 500 that includes an integrated optical component 512. The compliant mount 500 includes a base 502, a carrier 504, and a set of flexible connectors 506a-506d moveably connecting the carrier 504 to the base 502. The set of flexible connectors 506a-506d may be configured as a set of flexures (e.g., including a first flexure 506a, a second flexure 506b, a third flexure 506c, and a fourth flexure 506d) that suspend the carrier 504 relative to the base 502.

In the variation shown in FIG. 5, the compliant mount 500 may have a planar shape, such that the base 502, the carrier 504, and the set of flexible connectors 506a-506d are positioned in a common plane. In these variations, the carrier 504 may be moveable relative to the base 502 within this common plane. In some of these variations, the compliant mount 500 may be formed from a single sheet of material, in which some of the material is removed to define the base 502, the carrier 504, and the set of flexible connectors 506a-506d. For example, the compliant mount 500 may define a set of openings 508a-508d that extend through the compliant mount 500 to at least partially define the base 502, the carrier 504, and the set of flexible connectors 506a-506d.

The carrier 504 may be processed or otherwise shaped to form the integrated optical component 512. For example, in some variations the integrated optical component 512 may be a lens. In these variations, the compliant mount 500 may be formed form a material that is optically transparent at the wavelength(s) used to form the input light beam (e.g., plastic, silicon, or the like). The carrier 504 may be formed or processed to define one or more lens surfaces, such that light incident on the integrated optical component 512 is shaped by the lens as it passes the carrier 504. In other variations the integrated optical component 512 may be a diffuser. The compliant mount 500 may similarly be formed from an optically transparent material, and one or more surfaces of the carrier 504 may be formed or otherwise processed to define microstructures that will diffuse light as it passes through the integrated optical component 512.

The compliant mounts depicted in FIGS. 3A-5 are configured to provide translational movement between a base and a carrier, such that an unconstrained optical component carried by the compliant mount is translated within an optical measurement system as the unconstrained optical component vibrates with the optical measurement system. In other variations, a compliant mount may be configured to provide rotational movement between a base and a carrier. In these variations, an unconstrained optical component carried by the compliant mount is rotated within an optical measurement system as the unconstrained optical component vibrates relative to fixed portions of the optical measurement system.

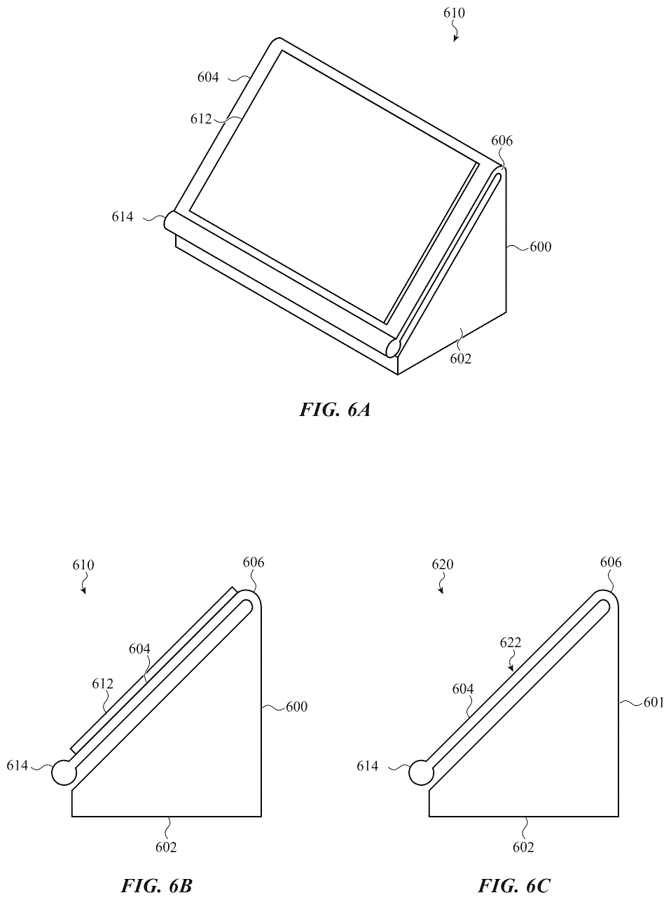

FIGS. 6A and 6B show perspective and side views, respectively, or a variation of a launch assembly 610 that includes a compliant mount 600. The compliant mount 600 includes a base 602, a carrier 604, and a set of flexible connectors 606 moveably connecting the carrier 604 to the base 602. In the variation shown in FIGS. 6A and 6B, each of the set of flexible connectors 606 is configured as a flexible hinge. While a single flexible hinge is shown in FIGS. 6A and 6B, it should be appreciated that the set of flexible connectors 606 may instead include a plurality of flexible hinges. When the base 602 of the compliant mount 600 is vibrated, the flexible hinge(s) may elastically deform and act as a pivot point such that the carrier 604 rotates relative to the base 602. Accordingly, when an optical component 612 (e.g., a mirror, diffuser, or the like) is attached to the carrier 604, vibration of the base 602 may cause the optical component 612 to rotate relative to the base 602. By connecting the base 602 to a fixed portion of the launch assembly 610 (e.g., either directly or indirectly via one or more intermediate components, such as a constrained optical component or an unconstrained optical component as described herein), the compliant mount 600 facilitate rotation of the optical component 612 within the launch assembly 610.

In some variations, the compliant mount 600 may be configured to limit the amount that the carrier 604 may rotate relative to the base 602 (e.g., to reduce the likelihood of plastic deformation within the carrier 604). For example, in the variation shown in FIG. 6A, the carrier 604 may include a stop portion 614 that protrudes toward the base 602. The stop portion 614 is positioned such that it may contact the base 602 as the carrier 604 rotates toward the base 602, which may prevent further rotation in that direction. Additionally or alternatively, the base 602 may include a corresponding stop portion (e.g., that protrudes toward the carrier 604) to limit rotation of the carrier 604.

In some variations, the compliant mount 600 may be configured to include an integrated optical component. For example, FIG. 6C shows another variation of a launch assembly 620 that includes a compliant mount 601 having an integrated optical component 622. The compliant mount 601 may be configured and labeled the same as the compliant mount 600, except that the compliant mount 601 includes an integrated optical component 622 formed from a portion of the carrier 604. For example, in some variations of the launch assembly 610 of FIGS. 6A and 6B, the optical component 612 may be a mirror that is formed by apply a layer of reflective material on the carrier 604 of the compliant mount 600. Conversely, the carrier 604 of compliant mount 601 of FIG. 6A may be formed from a reflective material (e.g., metal), such that a surface of the carrier 604 acts as a mirror.

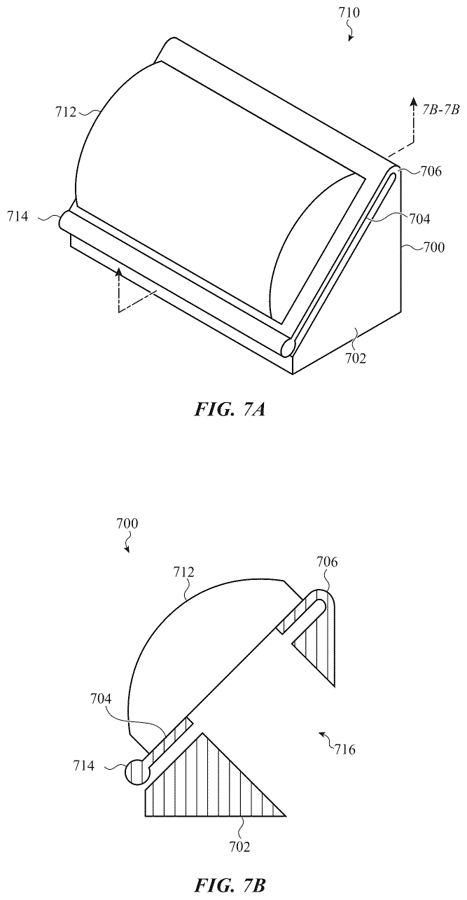

In some variations, a compliant mount such as the compliant mounts 600, 601 of FIGS. 6A-6C may hold or integrate an optical component as part of a launch assembly that is configured to pass light (e.g., an input light beam) is through the optical component. In some of these variations, the compliant mount may define an aperture that extends through the compliant mount. For example, FIGS. 7A and 7B show a perspective and a cross-sectional side (taken along line 7B-7B) of a variation of launch assembly 710 that includes a compliant mount 700 and an unconstrained optical component 712. The compliant mount 700 may include a base 702, carrier 704, and set of flexible connectors 706, which may be configured in any manner as described herein with respect to the compliant mount 600 of FIGS. 6A & 6B. In some variations, the compliant mount 700 may include a stop portion (e.g., stop portion 714) configured to limit rotation of the carrier 704 relative to the base 702.

The compliant mount 700 may define an aperture 716 (depicted in FIG. 7B) that extends through the compliant mount 700. For example, in the variation shown in FIG. 7B, the aperture 716 may extend through each of the carrier 704 and the base 702. In this way, when a light beam (e.g., an input light beam or a return light beam) or a portion thereof (e.g., in the instance of a beamsplitters) passes through the unconstrained optical component 712, this light may also pass through aperture 716, thereby allowing the light to pass through the compliant mount. By incorporating an aperture 716, the compliant mount 700 may be formed from one or more materials that is not transparent to the light passing through the unconstrained optical component 712. While the unconstrained optical component 712 is shown in FIGS. 7A and 7B as a lens, it should be appreciated that the unconstrained optical component 712 may be any suitable unconstrained optical components such as described herein.

To perform a measurement on a sample, the optical measurement systems described herein may perform a measurement sequence of individual measurements during a measurement session. During each individual measurement, the optical measurement system may emit an input light beam that is directed into a region of the sample. While emitting the input light beam, the optical measurement system measures light that returns from the sample using a corresponding set of detector elements (e.g., as one or more return light beams) of the plurality of detector elements. When the collection assembly of an optical measurement system includes multiple detector elements, each individual measurement may measure light using all of the detector elements or a corresponding subset of the detector elements as may be desired.

Because light of different wavelengths may interact differently with a given sample, it may be desirable for the measurement sequence to include multiple individual measurements performed at different wavelengths. In these instances, the input light beam may include light of different wavelengths during different individual measurements. In some instances, the optical measurement system may be configured to emit an input light beam having a single wavelength for certain individual measurements. In this way, the measurement sequence may include one or more individual measurements performed using a single wavelength (e.g., a first individual measurement that uses input light of a first wavelength, a second individual measurement that uses input light of a second wavelength, and so on). Additionally or alternatively, the optical measurement system may be configured to emit an input light beam that simultaneously includes multiple wavelengths of light for certain individual measurements. In these instances, the measurement sequence may include one or more individual measurements performed using multiple wavelengths (e.g., a first individual measurement that uses an input light beam having a first plurality of wavelengths, a second individual measurement that uses an input light beam having a second plurality of wavelengths, and so on). Information about the wavelength (or wavelengths) associated with each individual measurement may be used by the optical measurement system in determining one or more properties of the sample. In some variations, the one or more properties may include an estimate of the concentration of a particular substance within the sample.

The optical measurement systems described herein are configured to vibrate during one or more individual measurements of a measurement session, such that one or more unconstrained optical components will vibrate relative to one or more constrained optical components during these measurements. For example, the electronic device 100 may operate the haptic actuator 104 to vibrate the optical measurement system 102 while the optical measurement system 102 is performing a measurement. Accordingly, each unconstrained optical component of the set of unconstrained optical components 134 will vibrate relative to the set of constrained optical components 132 according to a corresponding frequency and direction.

Specifically, the controller 106 may initiate a measurement session during which the optical measurement system will perform a series of measurements on a sample. The controller 106 may analyze the results of these measurements to determine one or more properties of the sample. To the extent that the controller 106 is configured to operate the haptic actuator 104 to provide haptic feedback to a user of the electronic device 100, the controller 106 may limit what haptic feedback is provided to a user during a measurement session. For example, the controller 106 may forego providing haptic feedback to a user during the measurement session. Accordingly, even if certain system conditions exist that would normally cause the electronic device 100 to generate haptic feedback (e.g., the user receives a call or message on the electronic device 100, the user interacts with an input device), the controller 106 may not provide haptic feedback to the user.

In other instances, the controller 106 may operate the haptic actuator 104 to provide haptic feedback to a user between different measurements of the measurement session. For example, the controller 106 may operate the haptic actuator 104 to vibrate the optical measurement system 102 while the optical measurement system 102 is performing a series of measurements (e.g., during a first period of time). When the optical measurement system 102 is not actively performing a measurement (e.g., during a second period of time) the controller 106 may operate the haptic actuator 104 to provide haptic feedback to a user of the electronic device 100 (e.g., in response to certain systems conditions being met).

During the measurements of a measurement session, the controller 106 may control vibration of the optical measurement system 102 (e.g., by controlling the operation of the haptic actuator 104) to achieve a target frequency and a target amplitude of vibrations of certain unconstrained optical components within the optical measurement system 102. For example, the vibration of the optical measurement system 102 may be controlled such that a first unconstrained optical component (e.g., of the set of unconstrained optical components 134) vibrates within the optical measurement system 102 (e.g., relative to the set of constrained optical components 132) at a corresponding target frequency and with a corresponding target amplitude. The optical measurement system 102 may be configured to measure the relative movement of the first unconstrained optical component (e.g., using a position sensor), and may use the measured movement as feedback to control the vibrations generated by the haptic actuator 104 (and thereby the vibrations of the optical measurement system 102).

In some variations, the series of measurements performed during the measurement session, may include a plurality of individual measurements that are performed at different corresponding sets of wavelengths. During each of these measurements, the input light beam emitted by the optical measurement system 102 may be formed from light of a corresponding set of one or more wavelengths. The relative amounts of light returned at each wavelength may provide information about the sample, and may collectively be analyzed using a wide range of analytical techniques to determine one or more properties associated with a sample. Because the coherent noise state associated with a measurement may change as the first unconstrained optical component vibrates relative to the constrained optical components (e.g., by changing the phase distribution of the input light beam and/or a sample volume measured by the optical measurement system 102), it may be desirable for each measurement to be associated with a predetermined portion of a vibration period of the first optical component.

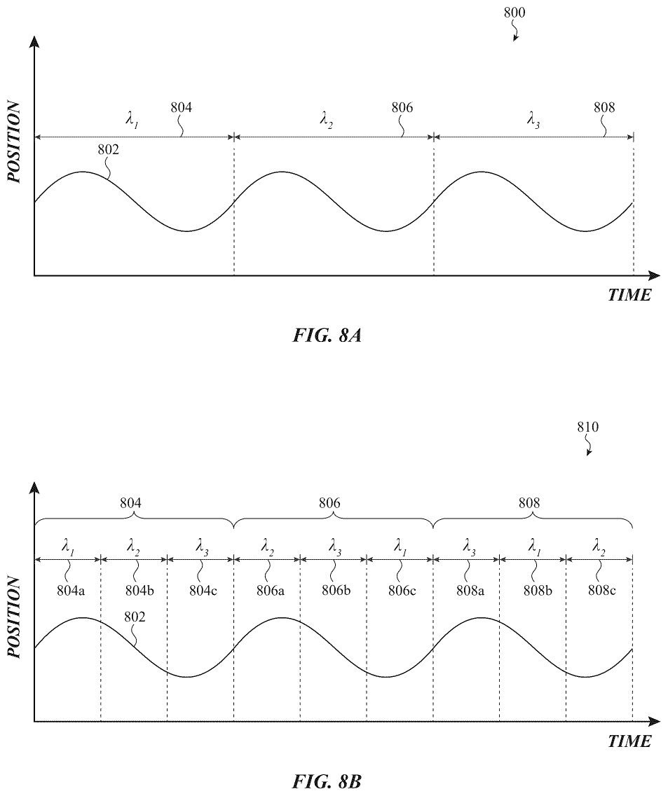

For example, FIG. 8A shows a timing diagram 800 that shows the relative position (represented by line 802) of the first unconstrained optical component within the optical measurement system 102 as it vibrated relative to the optical measurement system 102. The position of the first unconstrained optical component may vary sinusoidally over time according to a correspond frequency and amplitude. As used herein, a “vibration period” refers to the amount of time it takes for an unconstrained optical component to complete a single vibration. For example, three vibration periods (e.g., a first vibration period 804, a second vibration period 806, and a third vibration period 808) of the first unconstrained optical component are shown in FIG. 8A.

In some variations, a plurality of measurements is configured such that each individual measurement is performed during a different corresponding vibration period. For example, in the variation shown in FIG. 8A, the plurality of measurements may include a first measurement that is performed during the first vibration period 804 using a first wavelength λ₁, a second measurement that is performed during the second vibration period 806 using a second wavelength λ₂, and a third measurement that is performed during the third vibration period 808 using a third wavelength λ₃. Each of the first, second, and third measurements may have a common duration (e.g., equal to the duration of the vibration period, assuming the first, second, and third vibration periods have a common duration). Accordingly, because the plurality of measurements experience the same range of positions of the first unconstrained optical component, the plurality of measurements may experience similar changes to the coherent noise patterns associated with these measurements.

In other variations, a plurality of measurements may be configured such that multiple measurements are performed during a corresponding vibration period. For example, FIG. 8B shows another timing diagram 810 that includes the three vibration periods 804, 806, 808 of the position 802 of the first unconstrained optical component. As shown there, each vibration period may be divided into a plurality of subperiods (e.g., the first vibration period 804 is divided into a corresponding first subperiod 804a, second subperiod 804b, and third subperiod 804c, the second vibration period 806 is divided into a corresponding first subperiod 806a, second subperiod 806b, and third subperiod 806c, and the third vibration period 808 is divided into a corresponding first subperiod 808a, second subperiod 808b, and third subperiod 808c), and a corresponding plurality of measurements may performed during each subperiod.

For example, a first plurality of measurements may be performed during the first vibration period 804, such that a corresponding first measurement is performed during the first subperiod 804a using a first wavelength λ₁, a corresponding second measurement is performed during the second subperiod 804b using a second wavelength λ₂, and a corresponding third measurement is performed during the third subperiod 804c using a third wavelength λ₃. A second plurality of measurements may be performed during the second vibration period 806, such that a corresponding first measurement is performed during the first subperiod 806a using the second wavelength λ₂, a corresponding second measurement is performed during the second subperiod 806b using the third wavelength λ₃, and a corresponding third measurement is performed during the third subperiod 806c using the first wavelength λ₁. A third plurality of measurements may be performed during the third vibration period 808, such that a corresponding first measurement is performed during the first subperiod 808a using the third wavelength λ₃, a corresponding second measurement is performed during the second subperiod 808b using the first wavelength λ₁, and a corresponding third measurement is performed during the third subperiod 808c using the second wavelength λ₂.

Assuming each of the three vibration periods 804, 806, 808 are similarly divided (e.g., the first subperiods 804a, 806a, 808a have a first common duration, the second subperiods 804b, 806b, 808b have a second common duration, and the third subperiods 804c, 806c, 808c have a third common duration), the measurements of each wavelength will collectively experience a full vibration period of the first unconstrained optical component. For example, the plurality of measurements performed using the first wavelength λ₁ (e.g., during the first subperiod 804a of the first vibration period 804, the third subperiod 806c of the second vibration period 806, and the second subperiod 808b of the third vibration period 808) may collectively experience the full range of positions associated with a single vibration period. Similarly, the plurality of measurements performed using the second wavelength λ₂ and the plurality of measurements performed using the first wavelength λ₃ may each collectively experience the full range of positions associated with a single vibration period. In this way, measurements of multiple wavelengths may be interleaved, but the measurements associated with each wavelength may experience similar changes to the coherent noise patterns associated with these measurements. These principles may be extended to different numbers of wavelengths and/or vibration periods, and it should be appreciated that some vibration periods may include a measurement of a particular wavelength while other vibration periods may not.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electronic device comprising:
a haptic actuator;
an optical measurement system comprising a set of constrained optical components and a set of unconstrained optical components; and
a controller, wherein the controller is configured to:
operate the optical measurement system to perform a series of measurements during a first period of time; and
operate the haptic actuator to vibrate the optical measurement system during the series of measurements, wherein:
vibration of the optical measurement system during the series of measurements causes the set of unconstrained optical components to vibrate relative to the set of constrained optical components.

2. The electronic device of claim 1, wherein the controller is configured to operate the haptic actuator to provide haptic feedback to a user during a second period of time.

3. The electronic device of claim 1, wherein operation of the haptic actuator is controlled during the series of measurements such that a first unconstrained optical component of the set of unconstrained optical components vibrates relative to the set of constrained optical components at a corresponding target frequency and with a corresponding target amplitude.

4. The electronic device of claim 3, wherein:
the series of measurements comprises a plurality of measurements performed at different sets of wavelengths; and
each measurement of the plurality of measurements is performed during a different corresponding vibration period of the first unconstrained optical component.

5. The electronic device of claim 3, wherein:
the series of measurements comprises a plurality of measurements performed at different sets of wavelengths; and
the plurality of measurements is performed during a single vibration period of the first unconstrained optical component.

6. A method comprising:
at an electronic device comprising an optical measurement system and a haptic actuator:
performing, during a first period of time, a series of measurements using the optical measurement system; and
vibrating the optical measurement system, using the haptic actuator, during the series of measurements, wherein:
the optical measurement system comprises a set of constrained optical components and a set of unconstrained optical components; and
vibration of the optical measurement system during the series of measurements causes the set of unconstrained optical components to vibrate relative to the set of constrained optical components.

7. The method of claim 6, wherein comprising providing haptic feedback to a user of the electronic device during a second period of time.

8. The method of claim 6, wherein a first unconstrained optical component of the set of unconstrained optical components vibrates relative to the set of constrained optical components at a corresponding target frequency and a corresponding target amplitude during the series of measurements.

9. The method of claim 8, wherein:
performing the series of measurements comprises performing a plurality of measurements using different sets of wavelengths; and
each measurement of the plurality of measurements is performed during a different vibration period of the first unconstrained optical component.

10. The method of claim 7, wherein:
performing the series of measurements comprises performing a plurality of measurements using different sets of wavelengths; and
the plurality of measurements is performed during a common vibration period of the first unconstrained optical component.

11. An electronic device comprising:
an optical measurement system comprising:
a launch assembly configured to generate and emit an input light beam, the launch assembly comprising a set of constrained optical components and a set of unconstrained optical components; and
a collection assembly configured to collect one or more return light beams; and
a controller, wherein the controller is configured to:
operate the optical measurement system to perform a series of measurements while the optical measurement system is vibrated such that the set of unconstrained optical components vibrates relative to the set of constrained optical components.

12. The electronic device of claim 11, comprising:
a haptic actuator configured to vibrate the optical measurement system during the series of measurements.

13. The electronic device of claim 11, wherein:
vibration of a first unconstrained optical component relative to the set of unconstrained optical components during the series of measurements changes a phase distribution of the input light beam.

14. The electronic device of claim 13, wherein:
vibration of the first unconstrained optical component relative to the set of unconstrained optical components during the series of measurements changes a trajectory along which the input light beam is emitted from the optical measurement system.

15. The electronic device of claim 11, wherein:
vibration of a first unconstrained optical component relative to the set of unconstrained optical components during the series of measurements changes a trajectory along which the input light beam is emitted from the optical measurement system.

16. The electronic device of claim 11, wherein the set of unconstrained optical components comprises a lens.

17. The electronic device of claim 16, wherein:
the launch assembly comprises a photonic integrated circuit; and
the lens is mounted to a photonic integrated circuit.

18. The electronic device of claim 11, wherein the set of unconstrained optical components comprises a diffuser.

19. The electronic device of claim 11, wherein the set of unconstrained optical components comprises an integrated optical component formed in a carrier of a compliant mount.

20. The electronic device of claim 19, wherein the integrated optical component is a mirror.
